(19) United States
(12) Patent Application Publication
(10) Pub. No.: US 2025/0197692 A1
(43) Pub. Date: Jun. 19, 2025

(54) TWO-COMPONENT POLYURETHANE ADHESIVE

(71) Applicants: DuPont Technology (Shanghai) Co., Ltd., Shanghai (CN); DUPONT CHINA HOLDING COMPANY LTD, Shenzhen, Guangdong (CN)

(72) Inventors: Yiqing HU, Shanghai (CN); Jinyong WANG, Shanghai (CN)

(21) Appl. No.: 18/846,019

(22) PCT Filed: Mar. 25, 2022
(86) PCT No.: PCT/CN2022/083090

§ 371 Date: Sep. 11, 2024

(51) Int. Cl. C09J 9/00; C09J 4/00; C09J 11/04; C09J 175/04

(52) U.S. Cl. CPC C09J 9/00; C09J 4/00; C09J 11/04; C09J 175/04

(57) ABSTRACT

Provided herein is a two-component, thermally-conductive, flame-retardant polyurethane adhesive.

### FIELD OF INVENTION

The present invention relates to the field of adhesives, in particular two-component polyurethane adhesives.

### BACKGROUND OF THE INVENTION

The use of aluminium alloy in the building blocks for car body design is growing due to the continuous drive for weight reduction. In particular for electrical vehicles (EV), where the battery brings extra weight to the entire vehicle. The battery itself uses a lot aluminium alloy for the various structures and components. For example the housing of the battery pack is typically made from aluminium, and the side and edge panels of battery modules are made of aluminium alloy as well. The joining of aluminium alloy to other components for the battery becomes critical. Adhesive bonding is the current popular joining method for aluminium in the automotive industry together with other joining methods such as welding, and riveting. The typical bonding strength needed for bonding structural components should be higher than 5 MPa, or preferably higher than 10 MPa.

The most commonly used adhesive to bond aluminium alloy is based on epoxy and acrylic chemistry. However, epoxy adhesives have a relatively slow curing speed, and they can be brittle in the cured state. This hinders the application of epoxy adhesives for structural bonding of aluminium alloy inside battery pack applications. Acrylic based adhesives often have an unpleasant smell, making them not very user friendly.

Polyurethane (PU) adhesives are typically used for bonding painted substrates and plastic components in automotive applications. However, PU adhesives do not typically provide strong, durable bonding to aluminium alloy, in particular, adhesion to aluminium decreases significantly when exposed to harsh weathering conditions such as high temperature and high humidity. In addition, for battery applications, the adhesive used inside of battery pack should be fire- or flame-resistant. Flame retardant additives typically used in polyurethane industry are halogen-containing or phosphorus-based. Unfortunately, these additives often lead to a dramatic reduction of adhesion or bonding performance of the adhesive, thereby detracting from the structural properties of the bonding system.

Increasingly, there is a trend in industry to bond the battery cells with thermally conductive adhesives which have the dual functions of providing thermal conductivity as well as structural bonding. For thermally conductive adhesives, usually high loadings of thermally conductive filler (>50 wt %) are needed in order to achieve thermal conductivity greater than 1 W/mK, making it difficult to maintain the structural properties, in particular adhesive strength to aluminum, particularly after aging.

### SUMMARY OF THE INVENTION

In a first aspect, the invention provides a two-component flame-resistant polyurethane adhesive formulation comprising:
(A) a first part, comprising:
(a1) a polyurethane prepolymer made from at least one polyol, at least one polyisocyanate and an aminosilane, wherein the prepolymer is partially terminated with silane moieties and has reactive NCO moieties;
(B) a second part, comprising:
(b1) one or more polyether polyols;
(b2) one or more catalysts capable of promoting the reaction of the NCO moieties of (a1) with (b1);
wherein Part A and/or Part B comprise aluminium hydroxide such that when Part A and Part B are mixed together to form an adhesive mixture (preferably in a 1:1 volumetric ratio), the aluminium hydroxide concentration is at least 50 wt % percent.

A method for adhering two or more substrates, comprising the steps:
(1) providing a two-component flame-resistant polyurethane adhesive formulation comprising:
   (A) a first part, comprising:
   (a1) a polyurethane prepolymer made from at least one polyol, at least one polyisocyanate and an aminosilane, wherein the prepolymer is partially terminated with silane moieties and has reactive NCO moieties;
   (B) a second part, comprising:
   (b1) one or more polyether polyols;
   (b2) one or more catalysts capable of promoting the reaction of the NCO moieties of (a1) with (b1);
   wherein Part A and/or Part B comprise aluminium hydroxide, such that
   when Part A and Part B are mixed together to form an adhesive mixture (preferably in a 1:1 volumetric ratio), the aluminium hydroxide concentration is at least 50 wt % percent;
(2) mixing Part A and Part B to provide an uncured adhesive;
(3) applying the uncured adhesive to at least one substrate;
(4) bringing the uncured adhesive into adhesive contact with a second substrate;
(5) allowing the uncured adhesive to cure.

An adhered assembly, comprising:
(1) a first substrate;
(2) a second substrate;
wherein the first and second substrate are adhered one to the other by a cured adhesive resulting from mixing together the following Parts A and B:
   (A) a first part, comprising:
   (a1) a polyurethane prepolymer made from at least one polyol, at least one polyisocyanate and an aminosilane, wherein the prepolymer is partially terminated with silane moieties and has reactive NCO moieties;
   (B) a second part, comprising:
   (b1) one or more polyether polyols;
   (b2) one or more catalysts capable of promoting the reaction of the NCO moieties of (a1) with (b1);
   wherein Part A and/or Part B comprise aluminium hydroxide, such that when Part A and Part B are mixed together to form an adhesive mixture (preferably in a 1:1 volumetric ratio), the aluminium hydroxide concentration is at least 50 wt % percent, and allowing the mixture to cure.

### DETAILED DESCRIPTION OF THE INVENTION

The inventors have found that thermally-conductive, flame-retardant adhesives can be formulated with polyurethanes to offer i) lap shear strengths on aluminium of >7.5 MPa, ii) flame-retardancy ratings of V0, and iii) good retention of lap shear strength after prolonged exposure to harsh conditions.

### Definitions and Abbreviations

DSC Differential scanning calorimetry
MDI 4,4′-Methylenebis(phenyl isocyanate)
HDI Hexamethylene diisocyanate
IPDI isophorone diisocyanate
PU polyurethane
SEC size exclusion chromatography
RH relative humidity
ATH aluminium trihydroxide, aluminium hydroxide

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

The adhesive of the invention is a two-component polyurethane adhesive, comprising an A Part and B Part. The A Part and the B Part may be packaged together as a kit. The A Part and the B Part are mixed together at an appropriate ratio, preferably 1:1 by volume, prior to use and then applied as soon as practicable to the substrate or substrates.

The A Part and the B Part will now be disclosed in more particular detail.

### A Part (Isocyanate)

Part A comprises a polyurethane prepolymer made from at least one polyol, at least one polyisocyanate and an aminosilane, wherein the prepolymer is partially terminated with silane moieties and has reactive NCO moieties.

The polyisocyanate used to make the prepolymer may be aliphatic, aromatic, or a mixture, with aromatic polyisocyanates being preferred. Examples of aromatic polyisocyanates include methylene diphenyl diisocyanate (MDI), polycarbodiimide-modified MDI, toluene diisocyanate (TDI), p-phenylene diisocyanate (PPDI), and naphthalene diisocyanate (NDI). MDI is particularly preferred and/or polycarbodiimide-modified MDI. In some embodiments, a mixture of MDI and polycarbodiimide-modified MDI is used.

The polyisocyanate used to make the prepolymer is preferably used at 15-40 wt %, more preferably 17-35 wt %, particularly preferably 20-32 wt %, based on the total weight of Component A.

In a particularly preferred embodiment, the prepolymer is made using MDI and/or polycarbodiimide-modified MDI at 15-40 wt %, more preferably 17-35 wt %, particularly preferably 20-32 wt %, based on the total weight of Component A.

The polyol used to make the prepolymer is preferably a polyether polyol. The polyol may have two or more OH groups. Examples of polyether polyols include poly(alkylene oxide)diols, wherein the alkylene group is C₂-C₆, particularly preferably the alkylene group is C₂-C₄. Examples of suitable polyols include poly(ethylene oxide) polyols, poly(propylene oxide) polyols, poly(tetramethylene oxide) polyols. Particularly preferred are poly(propylene oxide) polyols, particularly poly(propylene glycol). In a preferred embodiment, the polyether polyol is a polyether polyol based on propylene glycol. In a particularly preferred embodiment, it is a polyether polyol based on propylene glycol with ethylene oxide capping, having a molecular weight of approximately 2,000 Da, a functionality of 2.

The polyether polyol used to make the prepolymer is preferably used at 5 to 20 wt %, more preferably 8 to 15 wt %, particularly preferably at 9 to 12 wt %, based on the total weight of Component A.

In a preferred embodiment, the polyol used to make the prepolymer is a polyether polyol based on propylene glycol, used at 5 to 20 wt %, more preferably 8 to 15 wt %, particularly preferably at 9 to 12 wt %, based on the total weight of Component A.

The polyisocyanate is used in excess to the polyether polyol such that the prepolymer is terminated with isocyanate groups. The final prepolymer preferably has an NCO wt % in the range of 5-30 wt %, more preferably in the range of 10-25 wt %.

The aminosilane in Component A is preferably of general Formula I or Formula II:

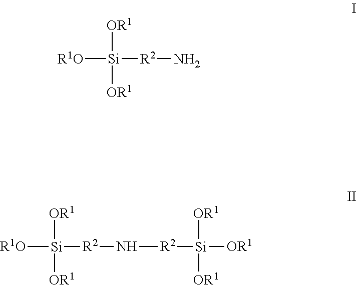

where R¹ is independently selected from C₁-C₆ alkyl, and R² is independently selected from C₂-C₆ alkylene.

In a preferred embodiment, the aminosilane in Component A is of general Formula I, R¹ is C₁-C₂ alkyl, and R² is C₂-C₄ alkylene. In a more preferred embodiment, the aminosilane is of general Formula I, R¹ is methyl, and R² is propylene.

In another preferred embodiment, the aminosilane in Component A is of general Formula II, R¹ is C₁-C₂ alkyl, and R² is C₂-C₄ alkylene. In a more preferred embodiment, the aminosilane is of general Formula II, R¹ is methyl, and R² is propylene.

In a particularly preferred embodiment, the aminosilane in Component A is bis-(trimethoxysilylpropyl)amine.

The aminosilane in Component A is preferably used at 0.5-4 wt %, more preferably 1-3 wt %, particularly preferably 1.5-2.5 wt %, based on the total weight of Component A.

In a preferred embodiment, the amino silane in Component A is bis-(trimethoxysilylpropyl)amine, used at 0.5-4 wt %, more preferably 1-3 wt %, particularly preferably 1.5-2.5 wt %, based on the total weight of Component A.

In a preferred embodiment, the prepolymer in Component A is made using:
polyisocyanate at 15-40 wt %, more preferably 17-35 wt %, particularly preferably 20-32 wt %, based on the total weight of Component A;
polyether polyol at 5 to 20 wt %, more preferably 8 to 15 wt %, particularly preferably at 9 to 12 wt %, based on the total weight of Component A; and
aminosilane at 0.5-4 wt %, more preferably 1-3 wt %, particularly preferably 1.5-2.5 wt %, based on the total weight of Component A.

In a more preferred embodiment, the prepolymer in Component A is made using:
MDI and/or polycarbodiimide-modified MDI, or a mixture of MDI and polycarbodiimide-modified MDI at 15-40 wt %, more preferably 17-35 wt %, particularly preferably 20-32 wt %, based on the total weight of Component A;
polyether polyol based on propylene glycol, preferably a polyether polyol based on propylene glycol having an OH value (mg KOH/g) of 109-115 at 5 to 20 wt %, more preferably 8 to 15 wt %, particularly preferably at 9 to 12 wt %, based on the total weight of Component A; and
aminosilane of general Formula II, wherein R¹ is C₁-C₂ alkyl, and R² is C₂-C₄ alkylene, more preferably R¹ is methyl, and R² is propylene at 0.5-4 wt %, more preferably 1-3 wt %, particularly preferably 1.5-2.5 wt %, based on the total weight of Component A.

In a particularly preferred embodiment, the prepolymer in Component A is made using:
a mixture of MDI and polycarbodiimide-modified MDI at 20-32 wt %, based on the total weight of Component A;
a polyether polyol based on propylene glycol having an OH value (mg KOH/g) of 109-115 at 9 to 12 wt %, based on the total weight of Component A; and
bis-(trimethoxysilylpropyl)amine at 0.5-4 wt %, more preferably 1-3 wt %, particularly preferably 1.5-2.5 wt %, based on the total weight of Component A.

The prepolymer is made by mixing the components, preferably under dry and/or inert atmosphere, for a period of time sufficient to result in reaction of substantially all of the polyol OH groups and the aminosilane amino groups with the polyisocyanate. In a preferred embodiment, mixing is carried out for 1 to 2 hours. The proportions are chosen so that the prepolymer is terminated with isocyanate groups and partially silane groups.

### Part B (Polyol)

Part B comprises:
one or more polyether polyols; and
one or more catalysts capable of promoting the reaction of the NCO moieties of the prepolymer with the polyol of Component B.

The polyol used in Component B is a polyether polyol. The polyol may have two or more OH groups. Examples of polyether polyols include poly(alkylene oxide)diols, wherein the alkylene group is C₂-C₆, particularly preferably the alkylene group is C₂-C₄. Examples of suitable polyols include poly(ethylene oxide) polyols, poly(propylene oxide) polyols, poly(tetramethylene oxide) polyols. Particularly preferred are poly(propylene oxide) polyols.

In a preferred embodiment, the polyether polyol of Component B is a diol.

In another preferred embodiment, the polyether polyol of Component B is a mixture of polyols having functionalities of 2-6. In a particularly preferred embodiment, the polyether polyol of Component B is a mixture of at least one diol, at least one triol and at least one polyol of functionality>3.

In a preferred embodiment, the polyether polyol of Component B is a mixture comprising or consisting of a diol, a triol, and a polyol having nominal functionality of 5-6.

In a preferred embodiment, the polyether polyol of Component B is a poly(propylene oxide) polyol having functionality of 2.

In a preferred embodiment, the polyether polyol of Component B is a mixture of poly(propylene oxide) polyols having functionalities of 2-6. In a particularly preferred embodiment, the polyether polyol of Component B is a mixture comprising or consisting of at least one poly(propylene oxide)diol, at least one poly(propylene oxide)triol and at least one poly(propylene oxide) polyol of functionality>3.

In a preferred embodiment, the polyether polyol of Component B is a mixture comprising or consisting of a poly(propylene oxide)diol, a poly(propylene oxide)triol and a poly(propylene oxide) polyol having nominal functionality of 5-6.

In another preferred embodiment, the polyether polyol of Component B consists of a poly(propylene oxide)diol.

In another preferred embodiment, the polyether polyol of Component B comprises 0-45 wt % of a polyether triol, 0-30 wt % of a polyether polyol having functionality>3, and 25-100 wt % of a polyether diol, based on the total weight of polyether polyol in Component B.

In another preferred embodiment, the polyether polyol of Component B comprises 5-45 wt % of a polyether triol, 10-35 wt % of a polyether polyol having functionality>3, and 30-80 wt % of a polyether diol, based on the total weight of polyether polyol in Component B.

In another preferred embodiment, the polyether polyol of Component B comprises 0-45 wt % of a poly(propylene oxide)triol, 0-30 wt % of a poly(propylene oxide) polyol having functionality>3, 25-100 wt % of a poly(propylene oxide)diol, based on the total weight of polyether polyol in Component B.

The total polyether polyol in Component B is preferably present at 15 to 50 wt %, more preferably 16 to 45 wt %, particularly preferably 18 to 42 wt %, based on the total weight of Component B.

In a preferred embodiment, Component B comprises 15 to 50 wt %, more preferably 16 to 45 wt %, particularly preferably 18 to 42 wt %, based on the total weight of Component B, of a mixture of polyether polyols comprising or consisting of:
(1) 30-45 wt % of a polyether triol, 19-30 wt % of a polyether polyol having functionality>3, 27-40 wt % of a polyether diol, based on the total weight of polyether polyol in Component B; or
(2) 5-15 wt % of a polyether triol, 10-25 wt % of a polyether polyol having functionality>3, 70-80 wt % of a polyether diol, based on the total weight of polyether polyol in Component B; or
(3) 100 wt % of a polyether diol, based on the total weight of polyether polyol in Component B; or
(4) 30-45 wt % of a poly(propylene oxide)triol, 19-30 wt % of a poly(propylene oxide) polyol having functionality>3, 27-40 wt % of a poly(propylene oxide)diol, based on the total weight of polyether polyol in Component B; or
(5) 5-15 wt % of a poly(propylene oxide)triol, 10-25 wt % of a poly(propylene oxide) polyol having functionality>3, 70-80 wt % of a poly(propylene oxide)diol, based on the total weight of polyether polyol in Component B.

Component B may optionally comprise a diol and/or triol of molecular weight<200 Da, more preferably <150 Da. Examples of diols include propylene glycol and butane diol, with butane diol (e.g. 1,4-butane diol) being particularly preferred. Examples of triols include glycerine and trimethylol propane, with glycerine being particularly preferred.

If present, the diol or triol of molecular weight<200 Da is preferably used at 2 to 8 wt %, more preferably 2.5-5 wt %, based on the total weight of Component B.

In a preferred embodiment, Component B comprises butane diol (e.g. 1,4-butane diol) at 2 to 8 wt %, more preferably 2.5-5 wt %, based on the total weight of Component B.

In another preferred embodiment, Component B comprises glycerine at 2 to 8 wt %, more preferably 2.5-5 wt %, based on the total weight of Component B.

Component B comprises one or more catalysts capable of promoting the reaction of the NCO moieties of the prepolymer of Component A with the one or more polyether polyols of Component B.

The catalyst is preferably selected from Lewis bases and Lewis acids. Preferred are tertiary amines, including diazabicyclo[2.2.2]octane, tris-2,4,6-((dimethylamino)methyl) phenol, DMDEE (2,2′-Dimorpholinodiethylether), imidazoles, such as 4-methylimidazole), triethanolamine, polyethyleneimine, with diazabicyclo[2.2.2]octane being particularly preferred.

Also suitable are organotin compounds, such as dioctyltindineodecanoate, dibutyltin di(acetate), and di-n-octyltin bis(isooctyl mercaptoacetate). With Di-n-octyltin bis(isooctyl mercaptoacetate) being particularly preferred.

The catalyst is preferably used at 0.005-0.02 wt %, more preferably 0.0075-0.015 wt %, particularly preferably 0.01 wt %, based on the total weight of Component B.

In a preferred embodiment, the catalyst is di-n-octyltin bis(isooctyl mercaptoacetate), used at 0.005-0.02 wt %, more preferably 0.0075-0.015 wt %, particularly preferably 0.01 wt %, based on the total weight of Component B.

### Aluminium Hydroxide

Part A and/or Part B comprise aluminium hydroxide, such that when Part A and Part B are mixed together to form an adhesive mixture (preferably in a 1:1 volumetric ratio), the aluminium hydroxide concentration is at least 50 wt %, based on the total weight of the adhesive mixture.

Preferably the aluminium hydroxide concentration in the adhesive mixture is 50-70 wt %, more preferably at 55-68 wt %, based on the total weight of the mixture.

In a preferred embodiment, the aluminium hydroxide is present in Component A at 50-70 wt %, more preferably at 55-68 wt %, based on the total weight of Component A.

In another preferred embodiment, the aluminium hydroxide is present in Component B at 50-70 wt %, more preferably at 55-68 wt %, based on the total weight of Component B.

In a preferred embodiment, the aluminium hydroxide is present in both Component A and Component B.

In another preferred embodiment, the aluminium hydroxide is present in both Component A and Component B at 50-70 wt %, more preferably at 55-68 wt %, based on the total weight of the respective Component.

In a preferred embodiment, the aluminium hydroxide has a D₅₀ of about 20 microns.

Preferably the adhesive mixture resulting from mixing Components A and B (preferably in a 1:1 volumetric ratio) comprises aluminium hydroxide having a D₅₀ of about 20 microns, at 50-70 wt %, more preferably at 55-68 wt %, based on the total weight of the mixture.

In a preferred embodiment, Component A comprises aluminium hydroxide having a D₅₀ of about 20 microns at 50-70 wt %, more preferably at 55-68 wt %, based on the total weight of Component A.

In another preferred embodiment, Component B comprises aluminium hydroxide having a D₅₀ of about 20 microns, at 50-70 wt %, more preferably at 55-68 wt %, based on the total weight of Component B.

In another preferred embodiment, both Component A and Component B comprise aluminium hydroxide having a D₅₀ of about 20 microns, at 50-70 wt %, more preferably at 55-68 wt %, based on the total weight of the respective Component.

### Optional Ingredients in Components A and B

Components A and/or B may additionally comprise other ingredients, for example, talc, molecular sieves, silica (particularly amorphous silica), carbon black.

### Application to Substrate

Parts (A) and (B) are mixed and can be applied to a substrate using known methods, such as a manual application system or in an automated way with a pump system using 20 l pails or 200 l drums or any other preferred container.

Preferred substrates include aluminium, e-coated aluminium, e-coated steel, laser treated aluminium, or passivated aluminium.

### Characteristics

The cured adhesive composition resulting from mixing Components A and B preferably has a thermal conductivity, after curing and resting for 7 days at 23° C., 50% relative humidity, of at least 0.75 W/mK, more preferably at least 0.8 W/mK, when measured according to ASTM D 5470.

The cured adhesive composition resulting from mixing Components A and B preferably has a lap shear strength, on aluminium substrates, after curing and resting for 7 days at 23° C., 50% relative humidity, of 7.5 MPa or greater, more preferably 8 MPa or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 7 days of Cataplasma treatment of 6 MPa or greater, more preferably 8 MPa or greater, particularly preferably 9 MPa or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 168 hours at 85° C. and 85% relative humidity of 8 MPa or greater, more preferably 9 MPa or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 1,000 hours at 85° C. and 85% relative humidity of 8 MPa or greater, more preferably 9 MPa or greater, particularly preferably 10 MPa or greater, when measured according to the method given in the Examples.

The cured adhesive composition resulting from mixing Components A and B preferably has a UL94 rating of V0, after curing for 7 days at 23° C. and 50% relative humidity.

In a preferred embodiment, The cured adhesive composition resulting from mixing Components A and B (7 days at 23° C. and 50% relative humidity) has a lap shear strength, on aluminium substrates, after curing and resting for 7 days at 23° C., 50% relative humidity, of 7.5 MPa or greater, more preferably 8 MPa or greater, when measured according to the method given in the Examples, and a UL94 rating of V0, after curing for 7 days at 23° C. and 50% relative humidity.

In another preferred embodiment, the cured adhesive (7 days at 23° C. and 50% relative humidity) has a lap shear strength, on aluminium substrates, after 7 days of Cataplasma treatment of 6 MPa or greater, more preferably 8 MPa or greater, particularly preferably 9 MPa or greater, when measured according to the method given in the Examples, and a UL94 rating of V0, after curing for 7 days at 23° C. and 50% relative humidity.

In another preferred embodiment, the cured adhesive (7 days at 23° C. and 50% relative humidity) has a lap shear strength, on aluminium substrates, after 168 hours at 85° C. and 85% relative humidity, of 8 MPa or greater, more preferably 9 MPa or greater, when measured according to the method given in the Examples, and a UL94 rating of V0, after curing for 7 days at 23° C. and 50% relative humidity.

In another preferred embodiment, the cured adhesive composition resulting from mixing Components A and B (7 days at 23° C. and 50% relative humidity) has a lap shear strength, on aluminium substrates, after 1,000 hours at 85° C. and 85% relative humidity of 8 MPa or greater, more preferably 9 MPa or greater, particularly preferably 10 MPa or greater, when measured according to the method given in the Examples, and a UL94 rating of V0, after curing for 7 days at 23° C. and 50% relative humidity.

In another preferred embodiment, the cured adhesive composition resulting from mixing Components A and B has a lap shear strength, on aluminium substrates, after curing and resting for 7 days at 23° C., 50% relative humidity, of 7.5 MPa or greater, more preferably 8 MPa or greater, when measured according to the method given in the Examples, and a thermal conductivity of 0.75 W/mK or greater, more preferably 0.8 W/mK or greater, when measured according to ASTM D5470.

In another preferred embodiment, the cured adhesive composition resulting from mixing Components A and B has a lap shear strength, on aluminium substrates, after curing and resting for 7 days at 23° C., 50% relative humidity, followed by 7 days of Cataplasma treatment of 6 MPa or greater, more preferably 8 MPa or greater, particularly preferably 9 MPa or greater, when measured according to the method given in the Examples, and a thermal conductivity of 0.75 W/mK or greater, more preferably 0.8 W/mK or greater, when measured according to ASTM D5470.

In another preferred embodiment, the cured adhesive composition resulting from mixing Components A and B has a lap shear strength, on aluminium substrates, after curing and resting for 7 days at 23° C., 50% relative humidity, followed by 168 hours at 85° C. and 85% relative humidity of 8 MPa or greater, more preferably 9 MPa or greater, when measured according to the method given in the Examples, and a thermal conductivity of 0.75 W/mK or greater, more preferably 0.8 W/mK or greater, when measured according to ASTM D5470.

In another preferred embodiment, the cured adhesive composition resulting from mixing Components A and B has a lap shear strength, on aluminium substrates, after curing and resting for 7 days at 23° C., 50% relative humidity, followed by 1,000 hours at 85° C. and 85% relative humidity of 8 MPa or greater, more preferably 9 MPa or greater, particularly preferably 10 MPa or greater, when measured according to the method given in the Examples, and a thermal conductivity of 0.75 W/mK or greater, more preferably 0.8 W/mK or greater, when measured according to ASTM D5470.

### PARTICULARLY PREFERRED EMBODIMENTS

The following are particularly preferred embodiments of the invention:
1. A two-component flame-resistant polyurethane adhesive formulation comprising:
   (A) a first part, comprising:
      (a1) a polyurethane prepolymer made from at least one polyol, at least one polyisocyanate and an aminosilane, wherein the prepolymer is partially terminated with silane moieties and has reactive NCO moieties;
   (B) a second part, comprising:
      (b1) one or more polyether polyols;
      (b2) one or more catalysts capable of promoting the reaction of the NCO moieties of (a1) with (b1);
   wherein Part A and/or Part B comprise aluminium hydroxide such that when Part A and Part B are mixed together to form an adhesive mixture (preferably in a 1:1 volumetric ratio), the aluminium hydroxide concentration is at least 50 wt % percent.
2. A method for adhering two or more substrates, comprising the steps:
   (1) providing a two-component flame-resistant polyurethane adhesive formulation comprising:
      (A) a first part, comprising:
         (a1) a polyurethane prepolymer made from at least one polyol, at least one polyisocyanate and an aminosilane, wherein the prepolymer is partially terminated with silane moieties and has reactive NCO moieties;
      (B) a second part, comprising:
         (b1) one or more polyether polyols;
         (b2) one or more catalysts capable of promoting the reaction of the NCO moieties of (a1) with (b1);
   wherein Part A and/or Part B comprise aluminium hydroxide, such that when Part A and Part B are mixed together to form an adhesive mixture (preferably in a 1:1 volumetric ratio), the aluminium hydroxide concentration is at least 50 wt % percent;
   (2) mixing Part A and Part B to provide an uncured adhesive;
   (3) applying the uncured adhesive to at least one substrate;
   (4) bringing the uncured adhesive into adhesive contact with a second substrate;
   (5) allowing the uncured adhesive to cure.
3. An adhered assembly, comprising:
   (1) a first substrate;
   (2) a second substrate;
   wherein the first and second substrate are adhered one to the other by a cured adhesive resulting from mixing together the following Parts A and B:
      (A) a first part, comprising:
         (a1) a polyurethane prepolymer made from at least one polyol, at least one polyisocyanate and an aminosilane, wherein the prepolymer is partially terminated with silane moieties and has reactive NCO moieties;
      (B) a second part, comprising:
         (b1) one or more polyether polyols;
         (b2) one or more catalysts capable of promoting the reaction of the NCO moieties of (a1) with (b1);
   wherein Part A and/or Part B comprise aluminium hydroxide, such that when Part A and Part B are mixed together to form an adhesive mixture (preferably in a 1:1 volumetric ratio), the aluminium hydroxide concentration is at least 50 wt % percent, and allowing the mixture to cure.
4. Any one preceding embodiment, wherein the polyisocyanate used to make the prepolymer is selected from aliphatic polyisocyanates, aromatic polyisocyanates, and mixtures thereof.
5. Any one preceding embodiment, wherein the polyisocyanate used to make the prepolymer is selected from aromatic polyisocyanates.
6. Any one preceding embodiment, wherein the polyisocyanate used to make the prepolymer is selected from methylene diphenyl diisocyanate (MDI), polycarbodiimide-modified MDI, toluene diisocyanate (TDI), p-phenylene diisocyanate (PPDI), and naphthalene diisocyanate (NDI).
7. Any one preceding embodiment, wherein the polyisocyanate used to make the prepolymer is MDI and/or polycarbodiimide-modified MDI.
8. Any one preceding embodiment, wherein the polyisocyanate used to make the prepolymer is used at 15-40 wt %, more preferably 17-35 wt %, particularly preferably 20-32 wt %, based on the total weight of Component A.
9. Any one preceding embodiment, wherein the prepolymer is made using MDI and/or polycarbodiimide-modified MDI at 15-40 wt %, more preferably 17-35 wt %, particularly preferably 20-32 wt %, based on the total weight of Component A.
10. Any one preceding embodiment, wherein the polyol used to make the prepolymer is a polyether polyol.
11. Any one preceding embodiment, wherein the polyol used to make the prepolymer comprises polyols selected from poly(alkylene oxide)diols, wherein the alkylene group is C₂-C₆, particularly preferably the alkylene group is C₂-C₄, and mixtures thereof.
12. Any one preceding embodiment, wherein the polyol used to make the prepolymer comprises polyols selected from poly(ethylene oxide) polyols, poly(propylene oxide) polyols, poly(tetramethylene oxide) polyols, and mixtures thereof.
13. Any one preceding embodiment, wherein the polyol used to make the prepolymer comprises polyols selected from poly(propylene oxide) polyols.
14. Any one preceding embodiment, wherein the polyol used to make the prepolymer comprises a polyether polyol based on propylene glycol with ethylene oxide capping, having a molecular weight of approximately 2,000 Da, and a functionality of 2.
15. Any one preceding embodiment, wherein the polyether polyol used to make the prepolymer is used at 5 to 20 wt %, more preferably 8 to 15 wt %, particularly preferably at 9 to 12 wt %, based on the total weight of Component A.
16. Any one preceding embodiment, wherein the polyol used to make the prepolymer is a polyether polyol based on propylene glycol, used at 5 to 20 wt %, more preferably 8 to 15 wt %, particularly preferably at 9 to 12 wt %, based on the total weight of Component A.
17. Any one preceding embodiment, wherein the final prepolymer has an NCO wt % in the range of 5-30 wt %, more preferably in the range of 10-25 wt %.
18. Any one preceding embodiment, wherein the aminosilane in Component A is preferably of general Formula I or Formula II:

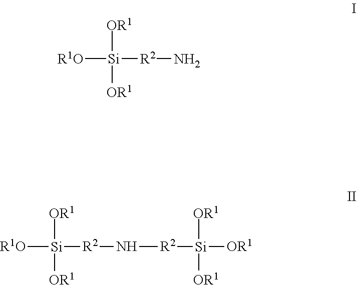

where R¹ is independently selected from C₁-C₆ alkyl, and R² is independently selected from C₂-C₆ alkylene.
19. Any one preceding embodiment, wherein the aminosilane in Component A is of general Formula I, R¹ is C₁-C₂ alkyl, and R² is C₂-C₄ alkylene. In a more preferred embodiment, the aminosilane is of general Formula I, R¹ is methyl, and R² is propylene.
20. Any one preceding embodiment, wherein the aminosilane in Component A is of general Formula II, R¹ is C₁-C₂ alkyl, and R² is C₂-C₄ alkylene.
21. Any one preceding embodiment, wherein the aminosilane is of general Formula II, R¹ is methyl, and R² is propylene.
22. Any one preceding embodiment, wherein the aminosilane in Component A is bis-(trimethoxysilylpropyl)amine.
23. Any one preceding embodiment, wherein the aminosilane in Component A is preferably used at 0.5-4 wt %, more preferably 1-3 wt %, particularly preferably 1.5-2.5 wt %, based on the total weight of Component A.
24. Any one preceding embodiment, wherein the amino silane in Component A is bis-(trimethoxysilylpropyl)amine, used at 0.5-4 wt %, more preferably 1-3 wt %, particularly preferably 1.5-2.5 wt %, based on the total weight of Component A.
25. Any one preceding embodiment, wherein the prepolymer in Component A is made using:
   polyisocyanate at 15-40 wt %, more preferably 17-35 wt %, particularly preferably 20-32 wt %, based on the total weight of Component A;
   polyether polyol at 5 to 20 wt %, more preferably 8 to 15 wt %, particularly preferably at 9 to 12 wt %, based on the total weight of Component A; and
   aminosilane at 0.5-4 wt %, more preferably 1-3 wt %, particularly preferably 1.5-2.5 wt %, based on the total weight of Component A.
26. Any one preceding embodiment, wherein the prepolymer in Component A is made using:
   MDI and/or polycarbodiimide-modified MDI, or a mixture of MDI and polycarbodiimide-modified MDI at 15-40 wt %, more preferably 17-35 wt %, particularly preferably 20-32 wt %, based on the total weight of Component A;
   polyether polyol based on propylene glycol, preferably a polyether polyol based on propylene glycol having an OH value (mg KOH/g) of 109-115 at 5 to 20 wt %, more preferably 8 to 15 wt %, particularly preferably at 9 to 12 wt %, based on the total weight of Component A; and
   aminosilane of general Formula II, wherein R¹ is C₁-C₂ alkyl, and R² is C₂-C₄ alkylene, more preferably R¹ is methyl, and R² is propylene at 0.5-4 wt %, more preferably 1-3 wt %, particularly preferably 1.5-2.5 wt %, based on the total weight of Component A.
27. Any one preceding embodiment, wherein the prepolymer in Component A is made using:
   a mixture of MDI and polycarbodiimide-modified MDI at 20-32 wt %, based on the total weight of Component A;
   a polyether polyol based on propylene glycol having an OH value (mg KOH/g) of 109-115 at 9 to 12 wt %, based on the total weight of Component A; and
   bis-(trimethoxysilylpropyl)amine at 0.5-4 wt %, more preferably 1-3 wt %, particularly preferably 1.5-2.5 wt %, based on the total weight of Component A.
28. Any one preceding embodiment, wherein the polyol used in Component B is a polyether polyol.
29. Any one preceding embodiment, wherein the polyol used in Component B has two or more OH groups.
30. Any one preceding embodiment, wherein the polyol used in Component B is selected from poly(alkylene oxide)diols, wherein the alkylene group is C₂-C₆, particularly preferably the alkylene group is C₂-C₄.
31. Any one preceding embodiment, wherein the polyol used in Component B is selected from poly(ethylene oxide) polyols, poly(propylene oxide) polyols, poly(tetramethylene oxide) polyols.
32. Any one preceding embodiment, wherein the polyol used in Component B is selected from poly(propylene oxide) polyols.
33. Any one preceding embodiment, wherein the polyol used in Component B comprises a polyol selected from polyether diols.
34. Any one preceding embodiment, wherein the polyether polyol of Component B is a mixture of polyols having functionalities of 2-6.
35. Any one preceding embodiment, wherein the polyether polyol of Component B is a mixture of at least one diol, at least one triol and at least one polyol of functionality>3.
36. Any one preceding embodiment, wherein the polyether polyol of Component B is a mixture comprising or consisting of a diol, a triol, and a polyol having nominal functionality of 5-6.
37. Any one preceding embodiment, wherein the polyether polyol of Component B comprises a poly(propylene oxide) polyol having functionality of 2.
38. Any one preceding embodiment, wherein the polyether polyol of Component B is a mixture of poly(propylene oxide) polyols having functionalities of 2-6.
39. Any one preceding embodiment, wherein the polyether polyol of Component B is a mixture comprising or consisting of at least one poly(propylene oxide)diol, at least one poly(propylene oxide)triol and at least one poly(propylene oxide) polyol of functionality>3.
40. Any one preceding embodiment, wherein the polyether polyol of Component B is a mixture comprising or consisting of a poly(propylene oxide)diol, a poly(propylene oxide)triol and a poly(propylene oxide) polyol having nominal functionality of 5-6.
41. Any one preceding embodiment, wherein the polyether polyol of Component B comprises 0-45 wt % of a polyether triol, 0-30 wt % of a polyether polyol having functionality>3, and 25-100 wt % of a polyether diol, based on the total weight of polyether polyol in Component B.
42. Any one preceding embodiment, wherein the polyether polyol of Component B comprises 5-45 wt % of a polyether triol, 10-35 wt % of a polyether polyol having functionality>3, and 30-80 wt % of a polyether diol, based on the total weight of polyether polyol in Component B.
43. Any one preceding embodiment, wherein the polyether polyol of Component B comprises 0-45 wt % of a poly(propylene oxide)triol, 0-30 wt % of a poly(propylene oxide) polyol having functionality>3, 25-100 wt % of a poly(propylene oxide)diol, based on the total weight of polyether polyol in Component B.
44. Any one preceding embodiment, wherein the total polyether polyol in Component B is present at 15 to 50 wt %, more preferably 16 to 45 wt %, particularly preferably 18 to 42 wt %, based on the total weight of Component B.
45. Any one preceding embodiment, wherein Component B comprises 15 to 50 wt %, more preferably 16 to 45 wt %, particularly preferably 18 to 42 wt %, based on the total weight of Component B, of a mixture of polyether polyols comprising or consisting of:
   (1) 30-45 wt % of a polyether triol, 19-30 wt % of a polyether polyol having functionality>3, 27-40 wt % of a polyether diol, based on the total weight of polyether polyol in Component B; or
   (2) 5-15 wt % of a polyether triol, 10-25 wt % of a polyether polyol having functionality>3, 70-80 wt % of a polyether diol, based on the total weight of polyether polyol in Component B; or
   (3) 100 wt % of a polyether diol, based on the total weight of polyether polyol in Component B; or
   (4) 30-45 wt % of a poly(propylene oxide)triol, 19-30 wt % of a poly(propylene oxide) polyol having functionality>3, 27-40 wt % of a poly(propylene oxide)diol, based on the total weight of polyether polyol in Component B; or
   (5) 5-15 wt % of a poly(propylene oxide)triol, 10-25 wt % of a poly(propylene oxide) polyol having functionality>3, 70-80 wt % of a poly(propylene oxide)diol, based on the total weight of polyether polyol in Component B.
46. Any one preceding embodiment, wherein Component B comprises a diol and/or triol of molecular weight<200 Da, more preferably <150 Da.
47. Any one preceding embodiment, wherein Component B comprises butane diol (e.g. 1,4-butane diol).
48. Any one preceding embodiment, wherein Component B comprises glycerine.
49. Any one preceding embodiment, wherein Component B comprises a diol or triol of molecular weight<200 Da at 2 to 8 wt %, more preferably 2.5-5 wt %, based on the total weight of Component B.
50. Any one preceding embodiment, wherein Component B comprises Component B comprises butane diol (e.g. 1,4-butane diol) at 2 to 8 wt %, more preferably 2.5-5 wt %, based on the total weight of Component B.
51. Any one preceding embodiment, wherein Component B comprises glycerine at 2 to 8 wt %, more preferably 2.5-5 wt %, based on the total weight of Component B.
52. Any one preceding embodiment, wherein the catalyst is selected from Lewis bases and Lewis acids.
53. Any one preceding embodiment, wherein the catalyst is selected from tertiary amines, organotin compounds, and combinations thereof.
54. Any one preceding embodiment, wherein wherein the catalyst comprises diazabicyclo[2.2.2]octane.
55. Any one preceding embodiment, wherein the catalyst comprises an organotin compounds.
56. Any one preceding embodiment, wherein the catalyst comprises di-n-octyltin bis(isooctyl mercaptoacetate).
57. Any one preceding embodiment, wherein the catalyst is used at 0.005-0.02 wt %, more preferably 0.0075-0.015 wt %, particularly preferably 0.01 wt %, based on the total weight of Component B.
58. Any one preceding embodiment, wherein the catalyst is di-n-octyltin bis(isooctyl mercaptoacetate), used at 0.005-0.02 wt %, more preferably 0.0075-0.015 wt %, particularly preferably 0.01 wt %, based on the total weight of Component B.
59. Any one preceding embodiment, wherein the aluminium hydroxide concentration in the adhesive mixture resulting from mixing Components A and B is 50-70 wt %, more preferably at 55-68 wt %, based on the total weight of the mixture.
60. Any one preceding embodiment, wherein the aluminium hydroxide is present in Component A at 50-70 wt %, more preferably at 55-68 wt %, based on the total weight of Component A.
61. Any one preceding embodiment, wherein the aluminium hydroxide is present in Component B at 50-70 wt %, more preferably at 55-68 wt %, based on the total weight of Component B.
62. Any one preceding embodiment, wherein the aluminium hydroxide is present in both Component A and Component B.
63. Any one preceding embodiment, wherein the aluminium hydroxide is present in both Component A and Component B at 50-70 wt %, more preferably at 55-68 wt %, based on the total weight of the respective Component.
64. Any one preceding embodiment, wherein the aluminium hydroxide has a D₅₀ of about 20 microns.
65. Any one preceding embodiment, wherein the adhesive mixture resulting from mixing Components A and B (preferably in a 1:1 volumetric ratio) comprises aluminium hydroxide having a D₅₀ of about 20 microns, at 50-70 wt %, more preferably at 55-68 wt %, based on the total weight of the mixture.
66. Any one preceding embodiment, wherein Component A comprises aluminium hydroxide having a D₅₀ of about 20 microns at 50-70 wt %, more preferably at 55-68 wt %, based on the total weight of Component A.
67. Any one preceding embodiment, wherein Component B comprises aluminium hydroxide having a D₅₀ of about 20 microns, at 50-70 wt %, more preferably at 55-68 wt %, based on the total weight of Component B.
68. Any one preceding embodiment, wherein both Component A and Component B comprise aluminium hydroxide having a D₅₀ of about 20 microns, at 50-70 wt %, more preferably at 55-68 wt %, based on the total weight of the respective Component.
69. Any one preceding embodiment, wherein the cured adhesive composition resulting from mixing Components A and B has a thermal conductivity, after curing and resting for 7 days at 23° C., 50% relative humidity, of at least 0.75 W/mK, more preferably at least 0.8 W/mK, when measured according to ASTM D5470.
70. Any one preceding embodiment, wherein the cured adhesive composition resulting from mixing Components A and B has a lap shear strength, on aluminium substrates, after curing and resting for 7 days at 23° C., 50% relative humidity, of 7.5 MPa or greater, more preferably 8 MPa or greater, when measured according to the method given in the Examples.
71. Any one preceding embodiment, wherein the cured adhesive composition resulting from mixing Components A and B has a lap shear strength, on aluminium substrates, after curing and resting for 7 days at 23° C., 50% relative humidity, followed by 7 days of Cataplasma treatment of 6 MPa or greater, more preferably 8 MPa or greater, particularly preferably 9 MPa or greater, when measured according to the method given in the Examples.
72. Any one preceding embodiment, wherein the cured adhesive composition resulting from mixing Components A and B has a lap shear strength, on aluminium substrates, after curing and resting for 7 days at 23° C., 50% relative humidity, followed by 168 hours at 85° C. and 85% relative humidity of 8 MPa or greater, more preferably 9 MPa or greater, when measured according to the method given in the Examples.
73. Any one preceding embodiment, wherein the cured adhesive composition resulting from mixing Components A and B has a lap shear strength, on aluminium substrates, after curing and resting for 7 days at 23° C., 50% relative humidity, followed by 1,000 hours at 85° C. and 85% relative humidity of 8 MPa or greater, more preferably 9 MPa or greater, particularly preferably 10 MPa or greater, when measured according to the method given in the Examples.
74. Any one preceding embodiment, wherein the cured adhesive composition resulting from mixing Components A and B has a UL94 rating of V0, after curing for 7 days at 23° C. and 50% relative humidity.
75. Any one preceding embodiment, wherein the cured adhesive composition resulting from mixing Components A and B (7 days at 23° C. and 50% relative humidity) has a lap shear strength, on aluminium substrates, after curing and resting for 7 days at 23° C., 50% relative humidity, of 7.5 MPa or greater, more preferably 8 MPa or greater, when measured according to the method given in the Examples, and a UL94 rating of V0, after curing for 7 days at 23° C. and 50% relative humidity.
76. Any one preceding embodiment, wherein the cured adhesive (7 days at 23° C. and 50% relative humidity) has a lap shear strength, on aluminium substrates, after 7 days of Cataplasma treatment of 6 MPa or greater, more preferably 8 MPa or greater, particularly preferably 9 MPa or greater, when measured according to the method given in the Examples, and a UL94 rating of V0, after curing for 7 days at 23° C. and 50% relative humidity.
77. Any one preceding embodiment, wherein the cured adhesive (7 days at 23° C. and 50% relative humidity) has a lap shear strength, on aluminium substrates, after 168 hours at 85° C. and 85% relative humidity, of 8 MPa or greater, more preferably 9 MPa or greater, when measured according to the method given in the Examples, and a UL94 rating of V0, after curing for 7 days at 23° C. and 50% relative humidity.
78. Any one preceding embodiment, wherein the cured adhesive composition resulting from mixing Components A and B (7 days at 23° C. and 50% relative humidity) has a lap shear strength, on aluminium substrates, after 1,000 hours at 85° C. and 85% relative humidity of 8 MPa or greater, more preferably 9 MPa or greater, particularly preferably 10 MPa or greater, when measured according to the method given in the Examples, and a UL94 rating of V0, after curing for 7 days at 23° C. and 50% relative humidity.
79. Any one preceding embodiment, wherein the cured adhesive composition resulting from mixing Components A and B has a lap shear strength, on aluminium substrates, after curing and resting for 7 days at 23° C., 50% relative humidity, of 7.5 MPa or greater, more preferably 8 MPa or greater, when measured according to the method given in the Examples, and a thermal conductivity of 0.75 W/mK or greater, more preferably 0.8 W/mK or greater, when measured according to ASTM D5470.
80. Any one preceding embodiment, wherein the cured adhesive composition resulting from mixing Components A and B has a lap shear strength, on aluminium substrates, after curing and resting for 7 days at 23° C., 50% relative humidity, followed by 7 days of Cataplasma treatment of 6 MPa or greater, more preferably 8 MPa or greater, particularly preferably 9 MPa or greater, when measured according to the method given in the Examples, and a thermal conductivity of 0.75 W/mK or greater, more preferably 0.8 W/mK or greater, when measured according to ASTM D5470.
81. Any one preceding embodiment, wherein the cured adhesive composition resulting from mixing Components A and B has a lap shear strength, on aluminium substrates, after curing and resting for 7 days at 23° C., 50% relative humidity, followed by 168 hours at 85° C. and 85% relative humidity of 8 MPa or greater, more preferably 9 MPa or greater, when measured according to the method given in the Examples, and a thermal conductivity of 0.75 W/mK or greater, more preferably 0.8 W/mK or greater, when measured according to ASTM D5470.
82. Any one preceding embodiment, wherein the cured adhesive composition resulting from mixing Components A and B has a lap shear strength, on aluminium substrates, after curing and resting for 7 days at 23° C., 50% relative humidity, followed by 1,000 hours at 85° C. and 85% relative humidity of 8 MPa or greater, more preferably 9 MPa or greater, particularly preferably 10 MPa or greater, when measured according to the method given in the Examples, and a thermal conductivity of 0.75 W/mK or greater, more preferably 0.8 W/mK or greater, when measured according to ASTM D5470.

### EXAMPLES

TABLE 1
Ingredients

| Trademark or | |
|---|---|
| abbreviation | Chemistry |
| POLYISO 1 | Polymeric MDI that contains MDI. |
| | Isocyanate equivalent weight: 134 g/mol |
| | % NCO: 31.4% (by weight) |
| | Average molecular weight 340 Da |
| | Nominal functionality: 2.7 |
| WANNATE | Polycarbodiimide-modified MDI |
| 1631 | |
| POLYOL 1 | a polyether polyol based on propylene glycol with |
| | ethylene oxide capping, having a molecular weight of |
| | approximately 2,000 Da, a functionality of 2 |
| Dynasilane | Bis(trimethoxysilylpropyl)amine |
| 1124 | |
| S7100 | Carbon black |
| ATH-20 | Aluminium trihydroxide with D₅₀ around 20 micron. |
| SK7800 | Talc |
| TS720 | Amorphous silica |
| Glycerine | Glycerine |
| 1,4-BDO | 1,4-butane diol |
| Voranol | A high reactivity capped polyether triol with high |
| 4701 | molecular weight and high primary hydroxyl content. |
| | Average equivalent weight: 1652.4 g/eq |
| | Average OH number: 33 mg KOH/g |
| | Molecular weight: 4957 g/mol |
| Voranol | sorbitol-initiated polyoxypropylene polyether |
| RN482 | polyol, having a hydroxyl number of 482, a nominal |
| | functionality of 6, and an equivalent weight of 117 |
| TP440 | a tri-functional polyol formed by adding propylene |
| | oxide to a trimethylolpropane nucleus |
| | Hydroxyl number 383-413 mg KOH/g |
| | Nominal functionality: 3 |
| | Nominal molecular weight: 400 Da |
| DABCO | 33% diazabicyclo[2.2.2]octane in 67% dipropylene |
| 33-LV | glycol. |
| UL-29 | Di-n-octyltin bis(isooctyl mercaptoacetate) |
| Purmol 4st | Molecular sieve |

### Manufacture of Part a (Isocyanate Component)

MDI, polyether polyol and aminosilane (Dynasilan 1124) in the amounts listed in Table 2, were first charged into a planetary mixer and mixed at room temperature for 2 hours at mixing speed between 300-1,000 rpm, and then the fillers ATH, MPP, talc, carbon black and amorphous silica were loaded into the mixture. The fillers were pre-dried in an oven at temperatures from 100-200° C. until the moisture level was below 1,000 ppm. The fillers were mixed into the mixture at a mixing speed of 1,000-2,000 rpm for 30-60 minutes. The mixture was then loaded into the cartridge for storage.

### Manufacture of Part B (Polyol Component)

The polyols, silane (Dynasilan) and catalyst in amounts indicated in Table 2 were mixed at 500-1,000 rpm for 5-15 min., and then the fillers ATH, MPP, talc, amorphous silica and molecular sieve were loaded into the mixture. The fillers were pre-dried in an oven at temperatures from 100-200° C. until the moisture level was below 1,000 ppm. The fillers were mixed into the mixture at a mixing speed of 1,000-2,000 rpm for 30-60 minutes. The mixture was then loaded into the cartridge for storage.

### Use of Adhesive

Parts A and B were mixed in a 1:1 volumetric ratio using a static mixer, and can be dispensed manually or robotically onto the substrates.

### Methods

### Flammability

Samples of adhesive were produced by mixing Part A and B in a 1:1 volumetric ratio, and allowing the mixture to cure at 23° C. for 7 days at 50% relative humidity. Flammability of the samples was measured according to UL94 flame tests. Samples were assigned a V0 rating if burning stopped within 10 seconds on a vertical specimen; drips of particles allowed as long as they are not inflamed. The results are reported in Table 2.

### Thermal Conductivity

Thermal conductivity was measured according to ASTM D5470. Three cured adhesive sample with 3 different thickness (1, 1.5, 2.5 mm) were prepared by mixing the A and B side through static mixer and cured at 23° C., 50% RH for 7 days and then cut into the desired shape and size using a cutter. The thermal conductivity test is carried out according to ASTM D 5470, thermal gel is applied between the testing rod and cured adhesive sample surface in order to minimize the interface thermal impedance from entrapped air. The set temperature of the sample is preferably between 20-50° C., and pressure applied to the sample is greater than 0.5 MPa.

### Lap Shear Testing

Lap shear strength was measured according to DIN EN1465, on aluminium alloy 3003. Aluminium substrates (from Novelis, AA6061 T6 1.92 mm MF noPT no lub, 140×25 mm, 1.9 mm thick) were used. The substrates were cleaned with isopropanol before use. The adhesive was produced by mixing Parts A and B in a 1:1 volumetric ratio and applied on one substrate, before the second substrate was joined within 5 minutes. The thickness was adjusted to 1.0 mm, the overlap area was 25 mm×25 mm. The material was cured and rested for 7 days at 23° C., 50% relative humidity before the lap shear tests were performed. The lap shear samples were then mounted in a tensiometer and the lap shear tests were performed, using a pull speed of 10 mm/min. The force deflection curve was monitored and the strength at break was reported as lap shear strength.

Lap shear tests were performed immediately after curing, as well as after 7 days cataplasm exposure (Cataplasma conditions are 7d @ 70° C., 100% relative humidity, followed by thermal shock at −30° C. for 24 hours), after 168 hours at 85° C. and 85% relative humidity, and after 1,000 hours at 85° C. and 85% relative humidity. The results are reported in Table 2.

TABLE 2
Composition of Inventive Examples (IE) and Comparative
Examples (CE) in wt %, based on the total weight
of the respective Component

| Ingredient | IE1 | IE2 | IE3 | CE4 | CE5 |
|---|---|---|---|---|---|
| A Component (isocyanate) | | | | | |
| POLYISO 1 | 30 | 22.45 | 20 | 30 | 20 |
| WANNATE 1631 | — | 5.3 | — | — | — |
| POLYOL 1 | 10 | 10.32 | 11 | 12 | 13 |
| Dynasilan 1124 | 2 | 1.96 | 2 | — | — |
| ATH-20 | 58 | 58.97 | 66 | 58 | 66 |
| TS720 | — | 1 | 1 | — | 1 |
| B Component (polyol) | | | | | |
| Dynasilan 1124 | — | — | — | 2 | — |
| POLYOL 1 | 14 | 13.51 | 20 | 12 | 20.2 |
| Glycerine | 3 | — | — | 3 | — |
| 1,4-BDO | — | — | 4 | — | 3.8 |
| Voranol 4701 | 15.98 | 1.98 | — | 15.98 | — |
| Voranol 482 | 11 | 2.895 | — | 11 | — |
| TP440 | — | 21.53 | — | — | — |
| DABCO 33-LV | 0.01 | 0.01 | — | 0.01 | — |
| UL-29 | — | 0.01 | 0.01 | 0.01 | 0.01 |
| ATH-20 | 56 | 57 | 72.99 | 56 | 73 |
| Purmol 4st | — | 3.065 | 3 | — | 3 |
| Data | | | | | |
| UL94 flame test | V₀ | V₀ | V₀ | V₀ | V₀ |
| Thermal conductivity (W/mk) | — | 0.8 | 1.3 | 0.8 | 1.3 |
| Lap shear strength at 23° C., | 11.1 | 10 | 8 | 7.2 | 6 |
| Aluminium alloy 3003 (MPa) | | | | | |

TABLE 2
Composition of Inventive Examples (IE) and Comparative
Examples (CE) in wt %, based on the total weight
of the respective Component

| Ingredient | IE1 | IE2 | IE3 | CE4 | CE5 |
|---|---|---|---|---|---|
| Lap shear strength at 23° C., | — | 10.1 | 9 | — | 2 |
| Aluminium alloy 3003 after 7 d | | | | | |
| Cataplasma (MPa) | | | | | |
| Lap shear strength at 23° C., | 9.9 | 12 | 10.3 | 3.3 | 3.5 |
| Aluminium alloy 3003 after 168 h | | | | | |
| 85° C. 85% RH (MPa) | | | | | |
| Lap shear strength at 23° C., | — | 12.7 | 10.2 | — | 0.8 |
| Aluminium alloy 3003 after 1000 h | | | | | |
| 85° C. 85% RH (MPa) | | | | | |

All the Inventive Examples and the Comparative Examples had the desired UL94 flame-retardant rating of V0, as well as acceptable thermal conductivity of >0.75 W/mK. However, Comparative Examples 4 and 5 had lap shear strengths immediately after curing for 7 days at 23° C., 50% relative humidity that were substantially lower than the Inventive Examples. Similarly, Comparative Examples 4 and 5 showed dramatic drops in lap shear strength under all the accelerated ageing conditions, whereas Inventive Examples 1 and 2 showed no decrease in lap shear strength, and even slight increases in lap shear strength.

1. A two-component flame-resistant polyurethane adhesive formulation comprising:
(A) a first part, comprising: (a1) a polyurethane prepolymer made from at least one polyol, at least one polyisocyanate and an aminosilane, wherein the prepolymer is partially terminated with silane moieties and has reactive NCO moieties;
(B) a second part, comprising: (b1) one or more polyether polyols; and (b2) one or more catalysts capable of promoting the reaction of the NCO moieties of (a1) with (b1);
wherein at least one of Part A and/or Part B comprise aluminium hydroxide such that when Part A and Part B are mixed together to form the adhesive formulation the aluminium hydroxide concentration is at least 50 wt. %, based on the total weight of the adhesive formulation.

2-82. (canceled)

83. The adhesive formulation of claim 1, wherein the polyisocyanate used to make the prepolymer is selected from aliphatic polyisocyanates, aromatic polyisocyanates, and mixtures thereof.

84. The adhesive formulation of claim 83, wherein the polyisocyanate used to make the prepolymer is selected from methylene diphenyl diisocyanate (MDI), polycarbodiimide-modified MDI, toluene diisocyanate (TDI), p-phenylene diisocyanate (PPDI), and naphthalene diisocyanate (NDI).

85. The adhesive formulation of claim 1, wherein the polyol used to make the prepolymer in component A is a polyether polyol.

86. The adhesive formulation of claim 85, wherein the polyol used to make the prepolymer in component A comprises polyols selected from poly(alkylene oxide)diols, wherein the alkylene group is C₂-C₆.

87. The adhesive formulation of claim 1, wherein the aminosilane in component A is of general Formula I or Formula II: 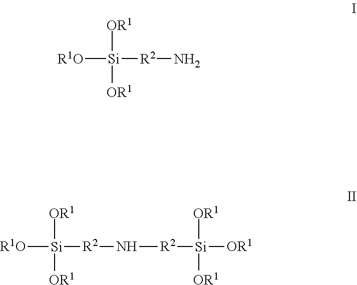
where R¹ is independently selected from C₁-C₆ alkyl, and R² is independently selected from C₂-C₆ alkylene.

88. The adhesive formulation of claim 1, wherein the prepolymer in component A is made using: a) a mixture of MDI and polycarbodiimide-modified MDI at 20-32 wt. %, based on the total weight of component A; b) a polyether polyol based on propylene glycol having an OH value (mg KOH/g) of 109-115 at 9 to 12 wt. %, based on the total weight of component A; and c) bis-(trimethoxysilylpropyl)amine at 0.5-4 wt. % based on the total weight of component A.

89. The adhesive formulation of claim 1, wherein the polyol used in component B is a polyether polyol.

90. The adhesive formulation of claim 89, wherein the polyol used in component B is selected from poly(alkylene oxide)diols, wherein the alkylene group is C₂-C₆.

91. The adhesive formulation of claim 90, wherein the polyol used in component B is selected from poly(ethylene oxide) polyols, poly(propylene oxide) polyols, poly(tetramethylene oxide) polyols.

92. The adhesive formulation of claim 90, wherein component B comprises 15 to 50 wt. % based on the total weight of Component B, of a mixture of polyether polyols comprising a) 30-45 wt. % of a polyether triol, b) 19-30 wt. % of a polyether polyol having functionality>3, and c) 27-40 wt. % of a polyether diol, all based on the total weight of polyether polyol in component B.

93. The adhesive formulation of claim 90, wherein component B comprises 1,4-butane diol.

94. The adhesive formulation of claim 90, wherein component B comprises glycerine.

95. The adhesive formulation of claim 90, wherein the catalyst is selected from Lewis bases and Lewis acids.

96. The adhesive formulation of claim 95, wherein the catalyst is used at 0.005-0.02 wt. %, based on the total weight of component B.

97. The adhesive formulation of claim 1, wherein the aluminium hydroxide is present in both component A and component B.

98. The adhesive formulation of claim 97, wherein both component A and component B comprise aluminium hydroxide having a D₅₀ of about 20 microns, at 50-70 wt. %, based on the total weight of the respective components.
